(19) United States
(12) Patent Application Publication
(10) Pub. No.: US 2014/0367559 A1
(43) Pub. Date: Dec. 18, 2014

(54) MOTOR WITH ENCODER

(71) Applicant: Kabushiki Kaisha Yaskawa Denki, Kitakyushu-shi (JP)

(72) Inventor: Naotake YOSHIZAWA, Fukuoka (JP)

(73) Assignee: Kabushiki Kaisha Yaskawa Denki, Kitakyushu-shi (JP)

(21) Appl. No.: 14/195,855

(22) Filed: Mar. 4, 2014

(30) Foreign Application Priority Data
Jun. 17, 2013 (JP) 2013-126508

(51) Int. Cl. G01D 5/347

(52) U.S. Cl. CPC G01D 5/3473
USPC 250/231.1

(57) ABSTRACT

A servo motor includes a motor including a shaft and a bracket on an opposite side of a load side, a disk connected to the shaft and having a plurality of reflecting slits formed along a circumferential direction, a light source configured to emit light to the reflecting slit, a light-receiving element configured to receive light emitted from the light source and reflected by the reflecting slit, a substrate provided with the light source and the light-receiving element, an encoder cover attached to the bracket so as to cover the disk and the substrate, and a support member provided on the encoder cover.

### CROSS-REFERENCE TO RELATED APPLICATION

This application is based upon and claims the benefit of priority from Japanese Patent Application No. 2013-126508, filed Jun. 17, 2013, the entire contents of which are incorporated herein by reference.

### BACKGROUND

1. Field

An embodiment of the disclosure relates to a motor with an encoder.

2. Description of the Related Art

In FIG. 3A of Japanese Patent Application Laid-Open No. H3-18719, an encoder in which an optical system configured of a light-emitting element, a fixed slit, a rotating slit, and a light-receiving element is sealed by an outer circumferential cylinder vertically provided on a flange and an electric circuit printed board on the outer circumferential cylinder are described.

### SUMMARY

According to an aspect of the present invention, there is provided a motor with an encoder including: a motor including a motor shaft and a housing; a disk connected to the motor shaft and having a plurality of reflecting slits formed along a circumferential direction; a light source configured to emit light to the reflecting slit; a light-receiving element configured to receive light emitted from the light source and reflected by the reflecting slit; a substrate provided with the light source and the light-receiving element; an encoder cover attached to the housing so as to cover the disk and the substrate; and a unit provided on the encoder cover and configured to fix the substrate.

Further, according to another aspect of the present invention, there is provided a motor with an encoder including: a motor including a motor shaft and a housing; a disk connected to the motor shaft and having a plurality of reflecting slits formed along a circumferential direction; a light source configured to emit light to the reflecting slit; a light-receiving element configured to receive light emitted from the light source and reflected by the reflecting slit; a substrate provided with the light source and the light-receiving element; and an encoder cover having an outer dimension smaller than that of the housing and attached to the housing so as to cover the disk and the substrate.

### BRIEF DESCRIPTION OF THE DRAWINGS

FIG. 1 is an explanatory drawing for explaining a schematic configuration of a servo motor according to an embodiment;

FIG. 2 is an explanatory drawing for explaining a configuration of a motor and an encoder according to the embodiment;

FIG. 3 is an explanatory drawing for explaining an example of a method of position adjustment between an optical module and a disk according to the embodiment;

FIG. 4 is an explanatory drawing for explaining an example of a method of position adjustment between the optical module and the disk according to the embodiment;

FIG. 5 is an explanatory drawing for explaining a configuration of a motor and an encoder according to a modification in which an external connector is fixed on a top portion of the encoder cover;

FIG. 6 is an explanatory drawing for explaining a configuration of a motor and an encoder according to a modification in which an external connector and a substrate is electrically connected via a conductive pin;

FIG. 7 is an explanatory drawing for explaining a configuration of a motor and an encoder according to a modification in which an external connector is provided on a substrate; and

FIG. 8 is an explanatory drawing for explaining an outer dimension of an encoder cover according to a modification in which an outer dimension of the encoder cover is smaller than a bracket on an opposite side of a load side.

### DETAILED DESCRIPTION

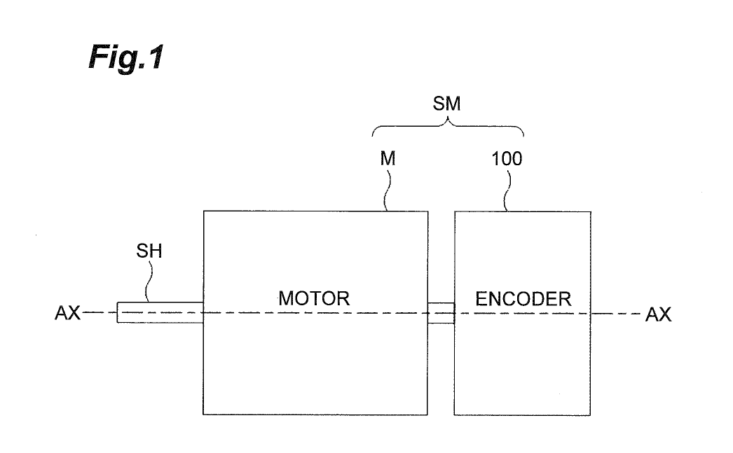

An embodiment is hereinafter described with reference to the drawings.

<1. Servo motor> First, a schematic configuration of a servo motor according to an embodiment will be described referring to FIG. 1.

As illustrated in FIG. 1, the servo motor SM (an example of a motor with an encoder) according to the embodiment includes a motor M and an optical encoder 100.

The motor M is an example of a power generation source which does not include the encoder 100. The motor M may solely be referred to as a servo motor. However, in the embodiment, the configuration including the encoder 100 will be referred to as the servo motor SM. Note that, for convenience of explanation, description will be made for the case in which the motor with an encoder is a servo motor controlled so as to follow the target values such as position and speed. However, the motor with an encoder is not necessarily limited to a servo motor. The motor with an encoder may be any motor attached with an encoder and includes motors used for a system other than a servo system. For example, the output of an encoder may be used just for displaying. The motor M includes a shaft SH (an example of a motor shaft) and outputs rotational force by rotating the shaft SH about a rotational axis AX.

Note that, the motor M can be any motor which is controlled based on data (e.g., position data which will be described below) detected by the encoder 100. Further, the motor M is not limited to an electric motor using electricity as a power source. The motor M may be a motor using other power sources such as a hydraulic motor, an air motor, and a steam motor. For convenience of explanation, description will be made for the case in which the motor M is an electric motor.

The encoder 100 is connected to the shaft SH, in an opposite side (also referred to as “opposite side of a load side”) of a rotational force output side (also referred to as “a load side”), of the motor M. Note that, the location at which the encoder 100 is connected is not particularly limited. For example, the encoder 100 may be connected to the shaft SH in the rotational force output side of the motor M, or connected to the shaft SH or the like via other mechanism such as a speed reduction gear, a rotational direction deflection unit, and a brake.

The encoder 100 detects the position (also referred to as “rotational angle”) of the motor M by detecting the position (angle) of the shaft SH, and outputs position data representing the position. Note that, the encoder 100 may detect at least either of the speed (also referred to as “rotational speed” or “angular speed”) or the acceleration (also referred to as “rotational acceleration” or “angular acceleration”) of the motor M in addition to, or instead of, the position of the motor M. In this case, the speed or the acceleration of the motor M can be detected by a processing, for example, a first or second order differentiation of position by time or a counting of a detecting signal for a predetermined period of time.

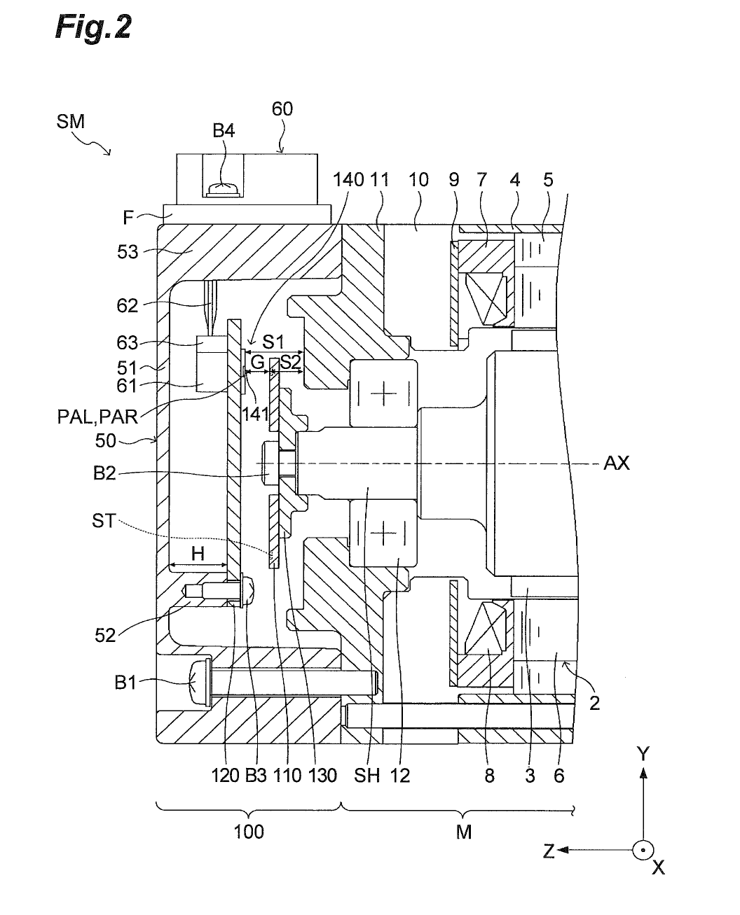

Now, referring to FIGS. 2 to 4, a configuration of the motor and the encoder according to the embodiment will be described.

For convenience of explanation of the configuration of the motor M and the encoder 100, directions along Z-axis, X-axis, Y-axis, or the like will be determined as below. That is, the direction along the rotational axis AX is determined as “Z-axis direction”, the direction toward the opposite side of the load side along the rotational axis AX is determined as “Z-axis positive direction”, and the direction toward the load side is determined as “Z-axis negative direction”. Further, the direction perpendicular to the Z-axis direction is determined as “X-axis direction”, and the direction perpendicular to the Z-axis direction and the X-axis direction is determined as “Y-axis direction”. Note that, the positional relation between each configuration of the motor M and the encoder 100 is not specifically limited to the idea of Z-axis, X-axis, and Y-axis directions or the like. Further, a remark will be made here that, according to convenience of explanation, other expressions or the like may be used for the directions determined above, or descriptions for other directions may be made with additional explanation as required.

<2. Motor> The motor M includes a stator 2, a rotor 3, a frame 4, a bracket on the load side which is not shown in the drawing, a bracket 11 on the opposite side of the load side (an example of a housing), and the shaft SH. The motor M is configured as a so-called “inner rotor” motor in which the rotor 3 is arranged inside the stator 2. Note that, the motor M is not limited to the case in which the motor M is configured as an inner rotor motor. The motor M may be configured as an “outer rotor” motor in which the rotor is arranged outside the stator. For convenience of explanation, the description will be made below for the case in which the motor M is configured as an inner rotor motor.

The stator 2 is provided on the inner circumferential surface of the frame 4 via an annular laminated core ring 5, and opposes the outer circumferential surface, in the radial direction, of the rotor 3. The stator 2 includes a stator core 6, a bobbin 7 attached to the stator core 6, and a coiled wire 8 wound around the bobbin 7, and is configured as an armature. The bobbin 7 is configured with an insulating material so as to electrically insulate the stator core 6 from the coiled wire 8. A substrate 9 is provided in the Z-axis positive direction side of the bobbin 7. The coiled wire 8 is electrically connected to the substrate 9 via a pin terminal which is not shown in the drawing. The bobbin 7, the coiled wire 8, the substrate 9, or the like are molded with resin 10.

The rotor 3 is provided on the outer circumferential surface of the shaft SH. The rotor 3 includes a magnet, not shown in the drawing, generating a magnetic field so as to be configured as a field magnet.

Note that, the motor M is not limited to the case in which the stator 2 is configured as an armature and the rotor 3 is configured as a field magnet. The stator may be configured as a field magnet and the rotor may be configured as an armature.

The bracket on the load side is provided in the Z-axis negative direction side of the frame 4, and the bracket 11 on the opposite side of the load side is provided in the Z-axis positive direction side of the frame 4.

The shaft SH is supported to rotate about the rotational axis AX by a bearing on the load side, which is not shown in the drawing, of which outer ring is engaged with the bracket on the load side and a bearing 12 on the opposite side of the load side of which outer ring is engaged with the bracket 11 on the opposite of the load side.

<3. Encoder> The encoder 100 is provided in the Z-axis positive direction side of the shaft SH. The encoder 100 includes a disk 110 which is a medium to be detected for detecting the position of the motor M. The encoder 100 is covered with an encoder cover 50.

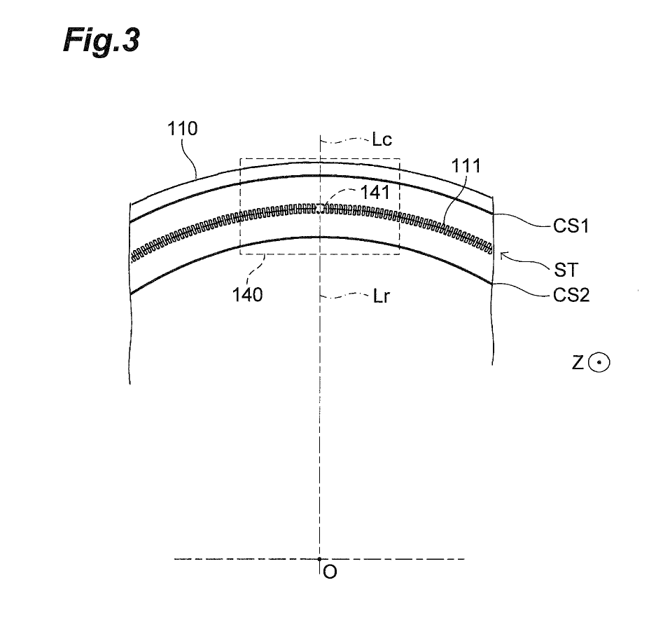

The disk 110 is formed in a ring shape with a material, for example, glass, metal, resin, or the like, and is fixed on the hub 130 in the Z-axis positive direction side so as to be concentric with the hub 130. The hub 130 is formed in a ring shape with a material, for example, metal, resin, or the like, and is fixed on the end portion, in the Z-axis positive direction side, of the shaft SH by a bolt B2 or the like so as to be concentric with the shaft SH. Therefore, the disk 110 is connected to the end portion, in the Z-axis positive direction, of the shaft SH via the hub 130 so that the disk center O (see FIG. 3) is approximately identical to the rotational axis AX, in other words, the disk is concentric with the shaft SH. In this manner, the disk 110 rotates about the rotational axis AX by the rotation of the shaft SH. Note that, the disk 110 is not limited to the case in which the disk 110 is connected to the shaft SH via the hub 130. The disk 110 may directly be connected to the shaft SH without the hub 130 in between. For convenience of explanation, description will be made below for the case in which the disk 110 is connected to the shaft SH via the hub 130.

As described above, the encoder 100 is configured as a so-called “built-in” encoder in which the disk 110 is connected to the shaft SH without an encoder shaft in between. Note that, the encoder 100 is not limited to the case in which the encoder 100 is configured as a built-in encoder. For example, the encoder 100 may be configured as a so-called “complete” encoder in which the disk 110 is connected to the shaft SH via an encoder shaft which is dedicated to the encoder 100. For convenience of explanation, description will be made below for the case in which the encoder 100 is configured as a built-in encoder.

Further, as illustrated in FIG. 3, a slit track ST having a ring shape with a disk center O in the center thereof is formed on the surface, in the Z-axis positive direction side, of the disk 110. The slit track ST is configured with a plurality of reflecting slits 111. The plurality of reflecting slits 111 is arrayed at a predetermined pitch in a track-like form along the circumferential direction (hereinafter also referred to as “disk circumferential direction”) of the disk 110.

Each reflecting slit 111 reflects light emitted by the light source 141 which will be described below. Note that, the reflecting slit 111 can be formed, for example, by configuring the surface, in the Z-axis positive direction side, of the disk 110 so as not to reflect light (so as to restrain reflection) and applying a light-reflecting material (e.g., aluminum) on a portion, used for reflecting light, of the surface. Further, the reflecting slit 111 can also be formed by configuring the surface, in the Z-axis positive direction side, of the disk 110 with a metal having high light-reflectivity, and reducing light-reflectivity of the portion, not used for reflecting light, of the surface by coarsening the portion by sputtering or the like or by applying a material having low light-reflectivity to the portion. As apparent from the forming method described as an example, the term “slit” is merely used, for convenience, to represent a region which reflects light, and does not represent a notch. Note that, the forming method for the reflecting slit 111 is not limited to the example described above.

In the example illustrated in FIG. 3, the plurality of reflecting slits 111 is arranged so as to have an incremental pattern in the disk circumferential direction. The incremental pattern is a pattern in which the reflecting slit 111 regularly repeats at a predetermined pitch. The incremental pattern represents the position of the motor M by a pitch or within a pitch, by a sum of an electric signal from one or more light-receiving elements 142 which will be described below. Note that, the plurality of reflecting slits 111 may be arranged so as to include a serial absolute pattern in the disk circumferential direction. The serial absolute pattern is a pattern in which the position, the ratio, or the like of the reflecting slit 111 is uniquely determined within a rotation of the disk 110.

The encoder cover 50 is fixed in the Z-axis positive direction side of the bracket 11 by a bolt B1 and the like so as to cover the disk 110, the substrate 120 which will be described below, or the like. Note that, the encoder cover 50 may be attached by a method other than fixing by a bolt or the like. Outer dimensions, in the X-axis and Y-axis directions, of the encoder cover 50 are approximately the same as those of the bracket 11, respectively. Note that, the encoder cover 50 is not limited to the case in which the outer dimensions, in the X-axis and Y-axis directions, of the encoder cover 50 are approximately the same as those of the bracket 11, respectively. For example, at least either of the outer dimensions in the X-axis and Y-axis directions may be larger than that of the bracket 11, or at least either of the outer dimensions in the X-axis and Y-axis directions may be smaller than that of the bracket 11.

For convenience of explanation, description will be made below for the case in which the outer dimensions, in the X-axis and Y-axis directions, of the encoder cover 50 are approximately the same as the outer dimensions, in the X-axis and Y-axis directions, of the bracket 11, respectively.

At a plurality of locations (e.g., three locations) on the inner surface of the top portion 51 of the encoder cover 50, a pillar-shaped support member 52 (an example of a unit which fixes the substrate) protruding toward the disk 110 side, that is, the Z-axis negative direction side is provided. These support members 52 are arrayed at an approximately even space in the circumferential direction of the encoder cover 50. Note that, the support member 52 may be provided at just a single location on the inner surface of the top portion 51. Further, the support member 52 is not limited to the case in which the support member 52 is formed in a pillar-shape protruding toward the Z-axis negative direction side. The support member 52 may be formed in a cylindrical shape (ring shape) or the like protruding toward the Z-axis negative direction side. The support member 52 is integrally formed with the encoder cover 50. The support member 52 is not limited to the case in which the support member 52 is integrally formed with the encoder cover 50. The support member 52 may be formed separately from the encoder cover 50. For convenience of explanation, description will be made for the case in which the support member 52 is integrally formed with the encoder cover 50.

The substrate 120 is fixed on the distal end portion of the support member 52 by a bolt B3 or the like. Note that, the substrate 120 is not limited to the case in which the substrate 120 is fixed by the bolt B3 or the like. The substrate 120 may be fixed by a method other than fixing by a bolt or the like. Further, the substrate 120 is not limited to the case in which the substrate 120 is fixed by the support member 52. The substrate 120 may be fixed by a unit for fixing the substrate 120, other than the support member 52. For convenience of explanation, description will be made below for the case in which the substrate 120 is fixed by the support member 52.

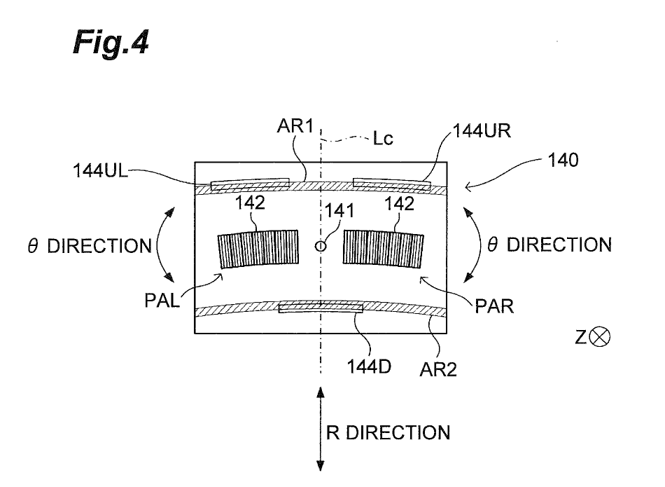

On the surface, in the Z-axis negative direction, of the substrate 120, an optical module 140 is attached so as to be approximately parallel to the disk 110 and to oppose a portion of the slit track ST. As illustrated in FIG. 4, the optical module 140 is formed in a substrate-form and includes a light source 141 and light-receiving arrays PAL and PAR. Note that, in this example, the optical module 140 is formed in a substrate-form so as to make the encoder 100 thinner or to make production of the encoder 100 easier. However, the optical module 140 is not necessarily be formed in a substrate-form.

The light source 141 is arranged on a center line Lc of the optical module 140. The center line Lc is on the surface, in the Z-axis negative direction side, of the optical module 140. Note that, the light source 141 is not necessarily be arranged on the center line Lc. For convenience of explanation, description will be made below for the case in which the light source 141 is arranged on the center line Lc. The light source 141 emits light to a portion of the slit track ST, passing the location opposing the light source 141, (hereinafter, the portion is also referred to as “irradiation region”).

Any light source capable of emitting light to the irradiation region can be used as the light source 141, and for example, LED (Light Emitting Diode) can be used. In the embodiment, the light source 141 is formed as a point light source and emits diffused light. An optical lens or the like is not particularly arranged in the point light source. Note that, regarding the point light source, the light source need not to be an exact point. It goes without saying that light may be emitted from a finite surface as long as the light source can be considered that diffused light is emitted from an approximately point-like location according to design or operating principle. By using the point light source as the light source 141 in this manner, diffused light can be emitted to the irradiation region and light can be emitted, approximately evenly, to the irradiation region, although there might be a certain degree of effect of, such as, change in a light amount caused by deviation from an optical axis or attenuation caused by a difference in an optical path length. Further, since any optical element for concentrating or diffusing light is not used, an error or the like caused by the optical element is not likely to occur, so that straightness of the emitted light toward the slit track ST can be improved.

The light-receiving arrays PAL and PAR are arranged around the light source 141 on the surface, in the Z-axis negative direction side, of the optical module 140. The light-receiving arrays PAL and PAR are configured with the plurality of light-receiving elements 142 arranged in an array-form at a predetermined pitch along the direction corresponding to the disk circumferential direction.

Each light-receiving element 142 receives light (reflected light) which is emitted from the light source 141 and reflected by the reflecting slit 111 of the slit track ST passing the location opposing the light source 141. Each light-receiving element 142 converts the received light into an electric signal corresponding to the received light amount and outputs the electric signal.

Any light-receiving element can be used as the light-receiving element 142 as long as the light-receiving element can receive the reflected light from the reflecting slit 111 and convert the received light into an electric signal corresponding to the received light amount. For example, a photodiode can be used.

As described above, the encoder 100 is configured as a so-called “reflection” encoder in which the light emitted from the light source 141 and reflected by the reflecting slit 111 is received by the light-receiving element 142. In such encoder 100, the light amount received by the light-receiving element 142 varies according to space (also referred to as “gap”) G between the optical module 140 (specifically, the light source 141 and the light-receiving element 142) and the disk 110. Further, since the light emitted from the light source 141 is not parallel light but diffused light, the size of an image (projection image) projected on the light-receiving arrays PAL and PAR varies according to the space G. Therefore, a value of the space G needs to be suitably provided to obtain reliability of the encoder 100. Note that, the space G is, specifically, a difference between a space S1, which is a space between the optical module 140 (specifically, the light source 141 and the light-receiving element 142) and the end portion of the bracket 11, and a space S2, which is a space between the surface, in the Z-axis positive direction, of the disk 110 and the end portion of the bracket 11. That is, the space G varies according to the value of the space S1 and the value of the space S2. Further, the space S1 varies according to the position of the optical module 140, that is, the value of protruding height H from the inner surface of the top portion 51 of the support member 52. Therefore, in the embodiment, the protruding height H of the support member 52 is determined so that the space G is a second value (corresponding to an example of a predetermined value) by the space S1 being a predetermined first value.

Further, in the servo motor SM, an external connector 60 arranged so that at least a portion of the external connector 60 is exposed outside the encoder cover 50 is provided. An external cable, not shown in the drawing, which allows transmission of information between the encoder 100 and electronic equipment arranged outside the encoder cover 50, not shown in the drawing, is connected to the external connector 60. In the servo motor SM according to the embodiment, a flange F of the external connector 60 is fixed on the outer surface of the side portion 53 of the encoder cover 50 by a bolt B4 or the like, and a lead wire 62 is pulled out to the inside of the encoder cover 50 from the external connector 60.

Further, a substrate-side connector 61 is provided on the surface, in the Z-axis positive direction side, of the substrate 120. An internal connector 63 provided on the distal end portion of the lead wire 62 is connected to the substrate-side connector 61. In this manner, the external connector 60 is electrically connected to the substrate-side connector 61 via the lead wire 62, so that the external connector 60 is electrically connected to the substrate 120.

<4. Position adjustment between optical module and disk> The servo motor SM having configuration as described above will be assembled as described below. First, the disk 110 is connected to the end portion, in the Z-axis positive direction side, of the shaft SH via the hub 130. Then, the encoder cover 50 in which the substrate 120 is fixed on the distal end portion of the support member 52 is arranged in the Z-axis positive direction side of the bracket 11 so as to be movable in the X-axis and Y-axis directions. Then, the encoder cover 50 is moved in the X-axis and Y-axis directions relative to the bracket 11. In this manner, the optical module 140 moves in the X-axis and Y-axis directions relative to the disk 110, and position adjustment (positioning) between the optical module 140 (specifically, the light source 141 and the light-receiving element 142) and the disk 110 (specifically, the reflecting slit 111) is carried out. After the position adjustment between the optical module 140 and the disk 110 is completed, the encoder cover 50 is fixed, in the Z-axis positive direction side, of the bracket 11.

In the above operation, the position adjustment between the optical module 140 and the disk 110 is preferably carried out with high accuracy. For this reason, in the embodiment, the position adjustment between the optical module 140 and the disk 110 is carried out using an electric signal from the light-receiving element provided on the optical module 140. Referring to FIGS. 3 and 4, an example of the method for carrying out the position adjustment between the optical module 140 and the disk 110 using an electric signal from the light-receiving element provided on the optical module 140 will be described below.

As illustrated in FIG. 3, ring-shaped concentric slits CS1 and CS2 having the disk center O in the center thereof are formed in the outer and inner circumference sides of the slit track ST on the surface, in the Z-axis positive direction side, of the disk 110. The concentric slits CS1 and CS2 are used for the position adjustment between the optical module 140 and the disk 110 via an electric signal from position adjustment light-receiving elements 144UL, 144UR, and 144D which will be described below. The concentric slits CS1 and CS2 are formed so as to have the same width and approximately the same distance from the slit track ST in the radial direction. The “slit” is merely used for convenience to represent the region which reflects light, and is not used to represent a notch.

As illustrated in FIG. 4, on the surface, in the Z-axis negative direction side, of the optical module 140, the light source 141, the light-receiving arrays PAL and PAR, the position adjustment light-receiving elements 144UL and 144UR, and the position adjustment light-receiving element 144D are provided.

The position adjustment light-receiving elements 144UL and 144UR receive the light (reflected light) which is emitted from the light source 141 and reflected by the concentric slit CS1 passing the location opposing the light source 141, convert the received light into an electric signal corresponding to the light amount, and output the electric signal. The position adjustment light-receiving elements 144UL and 144UR are arranged in the outer circumference side, in the direction corresponding to the radial direction of the disk 110 (also referred to as “disk radial direction”), than the light source 141 so as to be axisymmetric to each other with respect to the center line Lc. Specifically, the position adjustment light-receiving elements 144UL and 144UR are arranged as described below. That is, when the position adjustment between the optical module 140 and the disk 110 is suitably carried out, portions of the position adjustment light-receiving elements 144UL and 144UR overlap with a light-receiving region AR1 which receives the reflecting light from the concentric slit CS 1. More specifically, portions of the position adjustment light-receiving elements 144UL and 144UR in the direction corresponding to the disk radial direction (in the example, a portion in the inner side in the direction corresponding to the disk radial direction) overlap with the light-receiving region AR1, and the remaining portion does not overlap with the light-receiving region AR1.

The position adjustment light-receiving element 144D receives the light (reflecting light) which is emitted from the light source 141 and reflected by the concentric slit CS2 passing the location opposing the light source 141, converts the received light into an electric signal corresponding to the light amount, and outputs the electric signal. The position adjustment light-receiving element 144D is arranged in the inner circumference side, in the direction corresponding to the disk radial direction, than the light source 141 so as to be axisymmetric with respect to the center line Lc. Specifically, the position adjustment light-receiving element 144D is arranged as described below. That is, when the position adjustment between the optical module 140 and the disk 110 is suitably carried out, a portion of the position adjustment light-receiving element 144D overlaps with a light-receiving region AR2 which receives the reflecting light from the concentric slit CS2. More specifically, a portion of the position adjustment light-receiving element 144D in the direction corresponding to the disk radial direction (in the example, a portion in the outer side in the direction corresponding to the disk radial direction) overlaps with the light-receiving region AR2, and the remaining portion does not overlap with the light-receiving region AR2.

When the position adjustment between the optical module 140 and the disk 110 is suitably carried out, as illustrated in FIG. 3, the center line Lc is identical to the disk radial direction Lr (position adjustment in the θ direction as illustrated in FIG. 4), and the light source 141 is arranged so as to be located in the middle of the slit track ST (reflecting slit 111) in the disk radial direction (position adjustment in the R direction as illustrated in FIG. 4). The position adjustment light-receiving elements 144UL, 144UR, and 144D are set so that an electric signal output of each position adjustment light-receiving element is approximately the same with each other. Therefore, the position adjustment between the optical module 140 and the disk 110 can be carried out with high accuracy by moving the encoder cover 50 in the X-axis and Y-axis directions relative to the bracket 11 so that the output of the position adjustment light-receiving elements 144UL, 144UR, and 144D is approximately the same.

Note that, the method of the position adjustment between the optical module 140 and the disk 110 as described above is merely an example. The method is not limited as long as the method uses an electric signal from the light-receiving element provided on the optical module 140.

<5. Example of effect of the embodiment> The servo motor SM according to the embodiment as described above includes an encoder cover 50 attached to the bracket 11 of the motor M so as to cover the disk 110 and the substrate 120. A unit for fixing the substrate 120 (the support member 52, in the example described above) is provided in the encoder cover 50. The substrate 120 provided with the light source 141 and the light-receiving element 142 is fixed in the encoder cover 50.

The servo motor SM configured in such manner is assembled as described below. First, the disk 110 is connected to the shaft SH. Then, the position adjustment between the light source 141 and the light-receiving element 142, and the reflecting slit 111 of the disk 110 is carried out. The position adjustment is carried out with the encoder cover 50 in which the substrate 120 provided with the light source 141 and the light-receiving element 142 is fixed moving in the X-axis and Y-axis directions. Then, after the position adjustment is finished, the encoder cover 50 is fixed on the bracket 11.

In the embodiment, since the encoder cover 50 and the substrate 120 can integrally be handled as in this manner, the procedure from the position adjustment of the encoder 100 to the fixing of the encoder cover 50 can be simplified. Therefore, the assembling procedure can easily be automated.

Further, particularly in the embodiment, the support member 52 is used as a unit for fixing the substrate 120. The support member 52 is provided on the inner surface of the encoder cover 50 so as to protrude toward the Z-axis negative direction side. The substrate 120 is fixed on the distal end portion of the support member 52. In this manner, the substrate 120 can separately be arranged from the inner surface of the encoder cover 50, so that the substrate 120 can be arranged close to the disk 110 regardless of the magnitude of the dimension, in the Z-axis direction, of the encoder cover 50.

Further, on the condition that the substrate 120 is configured to be fixed in the bracket 11 side of the motor M via a support member, the support member needs to be provided independently from the bracket 11 to carry out the position adjustment of the substrate 120. Contrarily, in the embodiment, the encoder cover 50 and the support member 52 are integrally formed so that reduction of number of parts and reduction of cost can be achieved.

Further, particularly in the embodiment, the encoder 100 included in the servo motor SM is a reflection encoder configured to receive the light which is emitted from the light source 141 and reflected by the reflecting slit 111. Further, the protrusion height H of the support member 52 from the inner surface is determined so that the space G between the light source 141 and the light-receiving element 142 provided on the substrate 120 and the disk 110 is the second value. In this manner, the space G can be kept in a suitable value so that reliability of the encoder 100 can be obtained.

Further, particularly in the embodiment, the external connector 60 configured to be connected with an external cable is arranged so that at least a portion of the external connector 60 is exposed outside the encoder cover 50.

On the condition that the substrate 120 is configured to be fixed in the bracket 11 side of the motor M, the substrate 120 and the external connector 60 need to be electrically connected when the encoder cover 50 is attached in the assembling procedure. Since the connection is generally made via a wiring (lead wire or the like) provided in the inner side of the encoder cover 50, it is difficult to automate the connecting operation. As a result, attaching of the encoder cover 50 hinders the automation of the assembling procedure of the servo motor SM.

In the servo motor SM according to the embodiment, since the substrate 120 is fixed in the encoder cover 50 and the substrate 120 and the external connector 60 are electrically connected, the connecting operation is not necessary in the assembling procedure of the servo motor SM. Therefore, the assembling procedure can easily be automated.

Further, particularly in the embodiment, the external connector 60 and the substrate-side connector 61 provided on the substrate 120 are electrically connected via the lead wire 62. In this manner, delivering of the impact or vibration applied on the external connector 60 directly to the substrate 120 can be prevented, thereby protecting the substrate 120.

Further, particularly in the embodiment, the encoder 100 included in the servo motor SM is a built-in encoder in which the disk 110 is connected to the shaft SH without an encoder shaft in between. In the encoder 100, the disk 110 is directly connected to the shaft SH via the hub 130. Therefore, the encoder 100 can further be downsized (can be made thinner particularly in the Z-axis direction) compared to a complete encoder in which the disk 110 is connected to the shaft SH via an encoder shaft.

Note that, the effect or the like described above provided by the embodiment is merely an example, and it goes without saying that further effect or the like can be obtained.

<6. Modification> Detailed description is presented above for an embodiment referring to attached drawings. However, it goes without saying that the scope of the technical idea according to the claims is not limited by the embodiment described above. It is apparent that those skilled in the technical field in which the embodiment mentioned above belongs are able to make various modifications, alterations, combinations, or the like within the scope of the technical idea. Therefore, the art in which such modifications, alterations, combinations, or the like is applied is naturally included in the scope of the technical idea. Such modification or the like will be described below in order. Note that, for the modification or the like, description will be made below mainly for portions different from the embodiment described above. Further, a component having substantially the same function as that of the embodiment described above will be denoted with the same reference numeral, and description of such components may not be repeated and omitted.

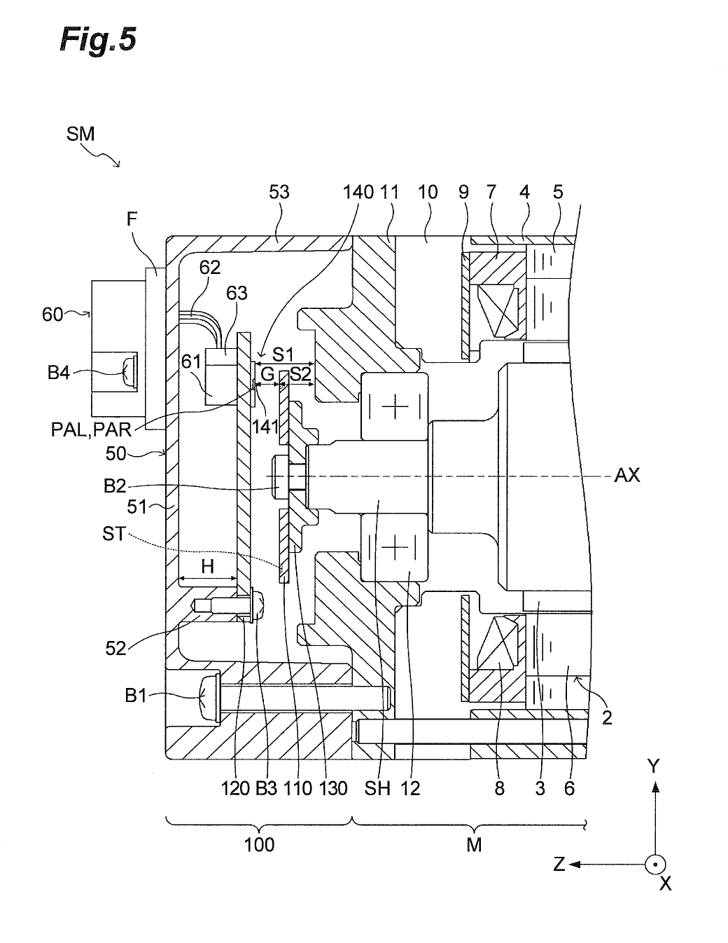

(6-1. The case in which external connector is fixed on top portion of encoder cover) In the embodiment described above, the flange F of the external connector 60 is fixed on the outer surface of the side portion 53 of the encoder cover 50. However, the location in which the external connector 60 is fixed is not limited to the outer surface of the side portion 53 of the encoder cover 50. Now, referring to FIG. 5, the differences in the servo motor according to the modification from the embodiment mentioned above will be described.

As illustrated in FIG. 5, in the servo motor SM according to the modification, the flange F of the external connector 60 is fixed on the outer surface of the top portion 51 of the encoder cover 50 by a bolt B4 or the like, and the lead wire 62 is pulled out to the inside of the encoder cover 50 from the external connector 60.

The configurations other than those described above are similar to the configurations of the embodiment, and the description thereof will not be repeated.

In the modification described above, similarly to the embodiment described above, the assembling procedure can easily be automated.

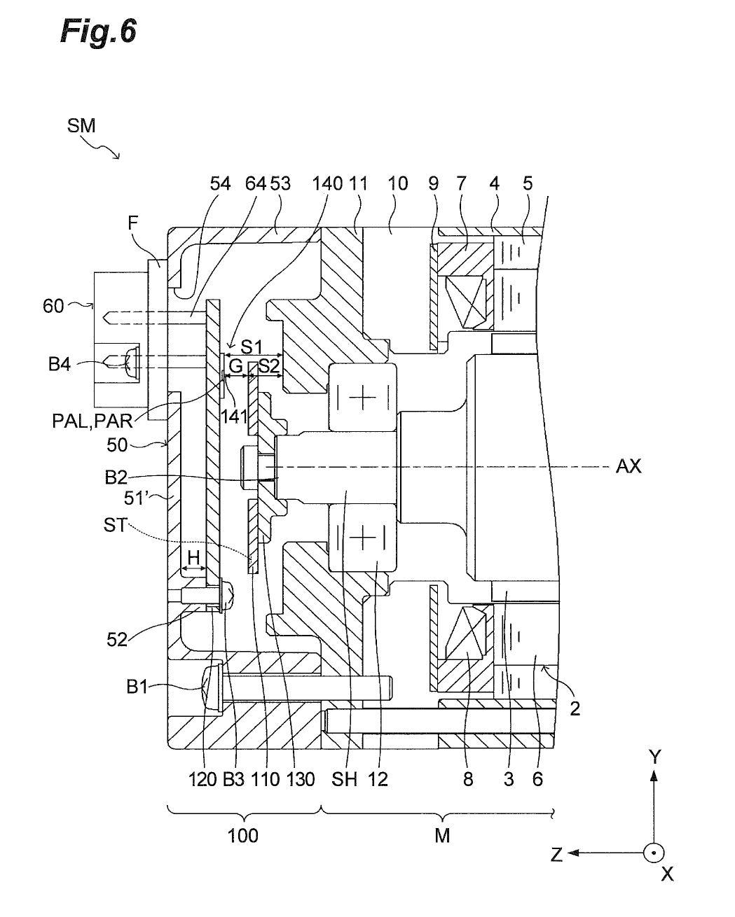

(6-2. The case in which external connector is electrically connected to substrate via conductive pin) In the embodiment described above, the external connector 60 and the substrate-side connector 61 are electrically connected via the lead wire 62. However, the method for connecting the external connector 60 and the substrate-side connector 61 is not limited to the method in which electrical connection is made via the lead wire 62. Now, referring to FIG. 6, the differences in the servo motor according to the modification from the embodiment mentioned above will be described.

As illustrated in FIG. 6, in the servo motor SM according to the modification, an opening 54 smaller than the outer dimension of the flange F of the external connector 60 is formed on the top portion 51′ of the encoder cover 50. Further, two conductive pins 64 are provided at the location, opposing the opening 54, on the surface, in the Z-axis positive direction side, of the substrate 120. The distal end portion of the pin 64 protrudes to the outside of the encoder cover 50 from the opening 54. Note that, the number of pins 64 is not limited to two. The number of pins 64 may be one or three or more. For convenience of explanation, description will be made below for the case in which the number of pins 64 is two.

The two pins 64 are inserted in two insertion ports, not shown in the drawing, provided on the flange F of the external connector 60, respectively. In this state, the flange F of the external connector 60 is fixed on the outer surface of the top portion 51′ by the bolt B4 or the like. In this manner, the external connector 60 and the substrate 120 are electrically connected via the pin 64. Note that, the number of insertion ports is not limited to two. The number of insertion ports may be one, or two or more. In the example in which the number of pins 64 is two as described above, the number of insertion ports is two. Further, the external connector 60 is not limited to the case in which the flange F is fixed on the outer surface of the top portion 51′, and the flange F may be fixed on the outer surface of the side portion 53 of the encoder cover 50.

The configurations other than those described above are similar to the configurations of the embodiment, and the description thereof will not be repeated.

In the modification described above, similarly to the embodiment described above, the assembling procedure can easily be automated.

Further, in the modification, the external connector 60 and the substrate 120 are electrically connected via the pin 64 provided on the substrate 120. In this manner, the external connector 60 and the substrate 120 can be electrically connected by simply inserting the pin 64 provided on the substrate 120 in the external connector 60. Consequently, the operation of connecting the external connector 60 and the substrate 120, made when the substrate 120 is fixed on the encoder cover 50, can be carried out easily.

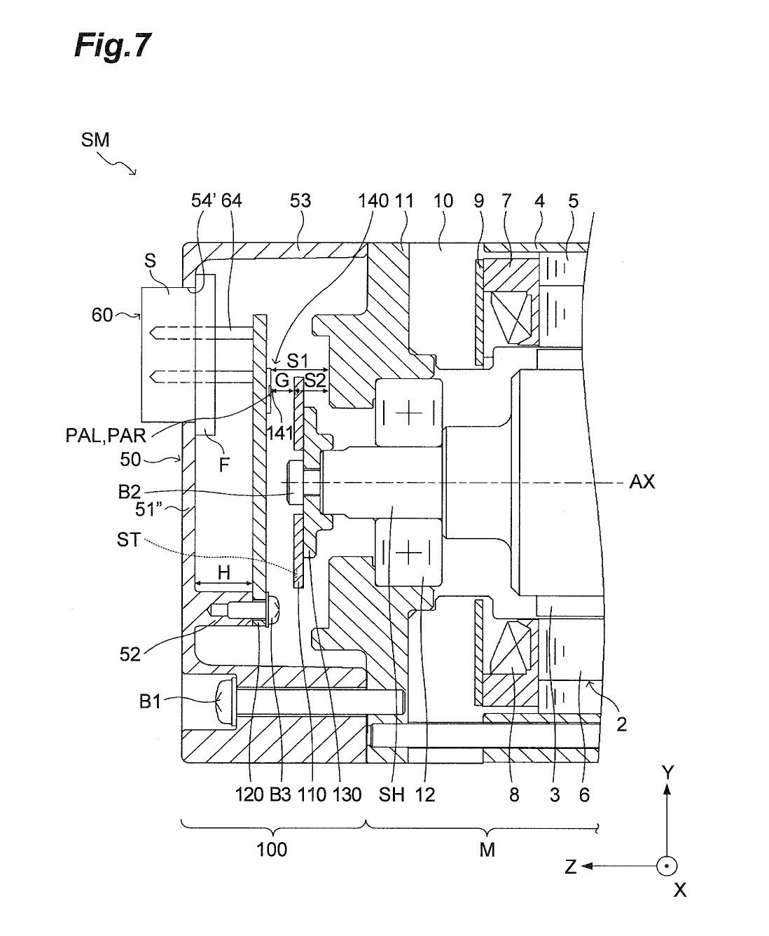

(6-3. The case in which external connector is provided on substrate) In the embodiment described above, the flange F of the external connector 60 is fixed on the outer surface of the encoder cover 50. However, the external connector 60 is not limited to the case in which the flange F is fixed on the outer surface of the encoder cover 50. Now, referring to FIG. 7, the differences in the servo motor according to the modification from the embodiment mentioned above will be described.

As illustrated in FIG. 7 in the servo motor SM according to the modification, an opening 54′ larger than the outer dimension of the main body S of the external connector 60 and smaller than the outer dimension of the flange F of the external connector 60 is formed on the top portion 51″ of the encoder cover 50. Further, the two pins 64 described above are provided at the location, opposing the opening 54′, on the surface, in the Z-axis positive direction side, of the substrate 120. The distal end portion of the pin 64 protrudes to the outside of the encoder cover 50 from the opening 54′. The two pins 64 are inserted in the two insertion ports provided on the external connector 60 described above, respectively. In this manner, the external connector 60 is integrally fixed on the surface, in the Z-axis positive direction, of the substrate 120 via the pin 64.

Further, by inserting the main body S in the opening 54′ from the inside of the encoder cover 50 with the flange F making contact with the inner surface of the top portion 51″, the external connector 60 is arranged so that a portion of the external connector 60 is exposed outside the encoder cover 50. Note that, the external connector 60 is not limited to the case in which the flange F is exposed from the top portion 51″. The flange F may be exposed from the side portion of the encoder cover 50.

The configurations other than those described above are similar to the configurations of the embodiment, and the description thereof will not be repeated.

In the modification described above, similarly to the embodiment described above, the assembling procedure can easily be automated.

Note that, the external connector 60 is not limited to the case in which the external connector 60 is provided on the substrate 120 via the pin 64. The external connector 60 may directly be provided on the substrate 120. By employing such configuration, a wiring or a pin for electrically connecting the external connector 60 and the substrate 120 is not necessary so that reduction of number of parts and reduction of cost can be achieved. Further, the operation of connecting the external connector 60 and the substrate 120 is unnecessary.

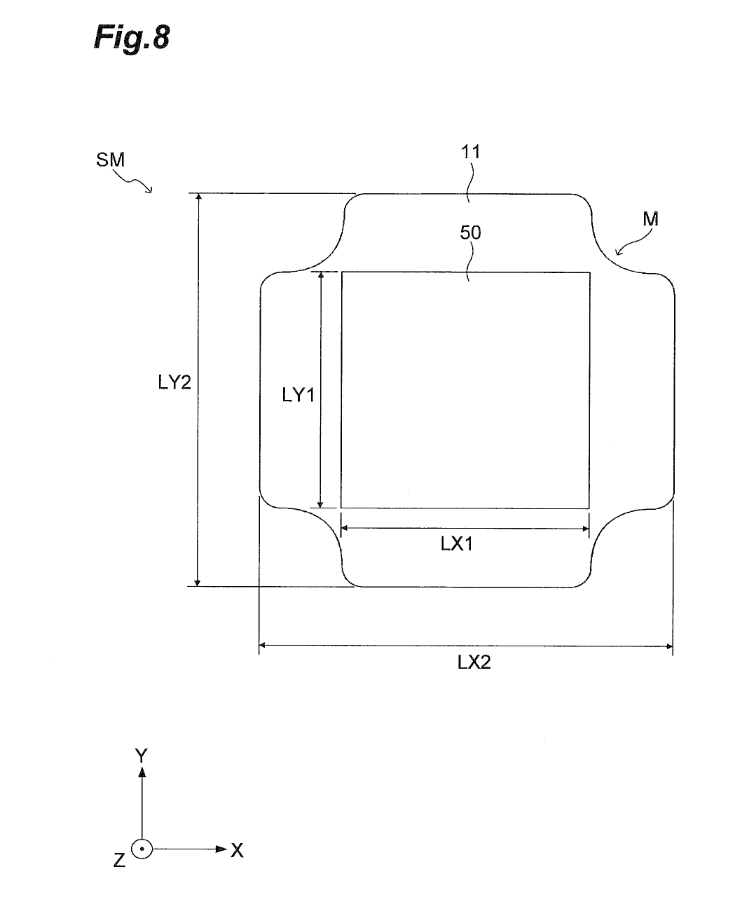

(6-4. The case in which outer dimension of encoder cover is smaller than bracket on opposite side of load side) In the embodiment described above, the outer dimensions in the X-axis and Y-axis directions of the encoder cover 50 are approximately the same as those of the bracket 11, respectively. However, the encoder cover 50 is not limited to the case in which the outer dimensions in the X-axis and Y-axis directions of the encoder cover 50 are approximately the same as those of the bracket 11, respectively. Now, referring to FIG. 8, the differences in the servo motor according to the modification from the embodiment mentioned above will be described. Note that, in FIG. 8, for convenience, illustration of the part of configuration of the servo motor SM other than the encoder cover 50 and the bracket 11 of the motor M is omitted.

As illustrated in FIG. 8, in the servo motor SM according to the modification, the outer dimensions LX1 and LY1, in the X-axis and Y-axis directions, of the encoder cover 50 are smaller than the outer dimensions LX2 and LY2, in the X-axis and Y-axis directions, of the bracket 11, respectively. Note that, in FIG. 8, the outer shape, viewed from the Z-axis positive direction side, of the encoder cover 50 is illustrated in an approximately square shape in which a recess is formed at each of the four corners. However, the outer shape, viewed from the Z-axis positive direction side, of the encoder cover 50 is not limited to the approximately square shape, and may be a rectangular shape, a circular shape, or the like. Further, the encoder cover 50 is not limited to the case in which both the outer dimensions LX1 and LY1 are smaller than the outer dimensions LX2 and LY2 of the bracket 11, respectively. For example, the encoder cover 50 may have the outer dimension LX1 smaller than the outer dimension LX2 of the bracket 11, and the outer dimension LY1 approximately the same as the outer dimension LY2 of the bracket 11. Furthermore, the encoder cover 50 may have the outer dimension LX1 approximately the same as the outer dimension LX2 of the bracket 11, and the outer dimension LY1 smaller than the outer dimension LY2 of the bracket 11. For convenience of explanation, description will be made below for the case in which the outer dimensions LX1 and LY1, in the X-axis and Y-axis directions, of the encoder cover 50 are smaller than the outer dimensions LX2 and LY2, in the X-axis and Y-axis directions, of the bracket 11, respectively.

The configurations other than those described above are similar to the configurations of the embodiment, and the description thereof will not be repeated.

In the modification described above, similarly to the embodiment described above, the assembling procedure can easily be automated.

Further, the following effect can be obtained by the modification. That is, as described above, the position adjustment between the light source 141 and the light-receiving element 142, and the reflecting slit 111 of the disk 110 is carried out with the encoder cover 50 provided with the substrate 120 moving in the X-axis and Y-axis directions. To carry out such position adjustment with high accuracy, the outer dimensions LX1 and LY1 of the encoder cover 50 need to be formed with high accuracy. Therefore, with consideration on an amount of work during production, cost, or the like, it is preferable to use a single type of encoder cover 50 having the fixed outer dimensions LX1 and LY1 regardless of the capacity (size) of the motor M, instead of changing the outer dimensions LX1 and LY1 of the encoder cover 50 according to the capacity of the motor M. Further, a single type of the encoder cover 50 advantageously requires a single type of an assembling apparatus for carrying out position adjustment.

In the modification, the outer dimensions LX1 and LY1 of the encoder cover 50 are smaller than the outer dimensions LX2 and LY2 of the bracket 11. On the condition that the outer dimensions LX1 and LY1 of the encoder cover 50 are provided to be equivalent to the outer dimensions LX2 and LY2 of the bracket 11, the outer dimensions LX1 and LY1 of the encoder cover 50 need to be changed according to the capacity of the motor M. However, by configuring the dimensions as in the modification, a single type of the encoder cover 50 having fixed outer dimensions LX1 and LY1 regardless of the capacity of the motor M can be used. Consequently, the position adjustment of the encoder 100 can be carried out with high accuracy.

Further, other than the cases as described above, the embodiment and a method for each modification may suitably be combined to be used.

Further, various modifications can be applied to the embodiment and each modification, without departing from the spirit and scope thereof, so as to be put in use. Although, description will not be made for each of the cases.

Indeed, the novel devices and methods described herein may be embodied in a variety of other forms; furthermore, various omissions, substitutions and changes in the form of the devices and methods described herein may be made without departing from the spirit of the inventions. The accompanying claims and their equivalents are intended to cover such forms or modification as would fall within the scope and spirit of the inventions.

Certain aspects, advantages, and novel features of the embodiment have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

What is claimed is:

1. A motor with an encoder comprising:
a motor including a motor shaft and a housing;
a disk connected to the motor shaft and having a plurality of reflecting slits formed along a circumferential direction;
a light source configured to emit light to the reflecting slit;
a light-receiving element configured to receive light emitted from the light source and reflected by the reflecting slit;
a substrate provided with the light source and the light-receiving element;
an encoder cover attached to the housing so as to cover the disk and the substrate; and
a unit provided on the encoder cover and configured to fix the substrate.

2. The motor with an encoder according to claim 1, wherein the unit configured to fix the substrate is a support member provided on an inner surface of the encoder cover so as to protrude toward the disk side, the substrate being fixed on a distal end portion of the support member.

3. The motor with an encoder according to claim 2, wherein a protruding height, from the inner surface, of the support member is determined so that a space between the light source and the light-receiving element provided on the substrate and the disk is a predetermined value.

4. The motor with an encoder according to claim 1, further comprising an external connector arranged so that at least a portion of the external connector is exposed outside the encoder cover, and configured to be electrically connected to the substrate and to be connected with an external cable.

5. The motor with an encoder according to claim 2, further comprising an external connector arranged so that at least a portion of the external connector is exposed outside the encoder cover, and configured to be electrically connected to the substrate and to be connected with an external cable.

6. The motor with an encoder according to claim 3, further comprising an external connector arranged so that at least a portion of the external connector is exposed outside the encoder cover, and configured to be electrically connected to the substrate and to be connected with an external cable.

7. The motor with an encoder according to claim 4, further comprising:
a substrate-side connector provided on the substrate; and
a lead wire electrically connecting the external connector and the substrate-side connector.

8. The motor with an encoder according to claim 5, further comprising:
a substrate-side connector provided on the substrate; and
a lead wire electrically connecting the external connector and the substrate-side connector.

9. The motor with an encoder according to claim 6, further comprising:
a substrate-side connector provided on the substrate; and
a lead wire electrically connecting the external connector and the substrate-side connector.

10. The motor with an encoder according to claim 4, further comprising a conductive pin provided on the substrate and electrically connecting the external connector and the substrate.

11. The motor with an encoder according to claim 5, further comprising a conductive pin provided on the substrate and electrically connecting the external connector and the substrate.

12. The motor with an encoder according to claim 6, further comprising a conductive pin provided on the substrate and electrically connecting the external connector and the substrate.

13. The motor with an encoder according to claim 4, wherein the external connector is provided on the substrate, and an opening for exposing at least a portion of the external connector outside is formed on the encoder cover.

14. The motor with an encoder according to claim 5, wherein the external connector is provided on the substrate, and an opening for exposing at least a portion of the external connector outside is formed on the encoder cover.

15. The motor with an encoder according to claim 6, wherein the external connector is provided on the substrate, and an opening for exposing at least a portion of the external connector outside is formed on the encoder cover.

16. The motor with an encoder according to claim 4, wherein the disk is connected to the motor shaft without having an encoder shaft in between.

17. The motor with an encoder according to claim 5, wherein the disk is connected to the motor shaft without having an encoder shaft in between.

18. The motor with an encoder according to claim 4, wherein an outer dimension of the encoder cover is smaller than that of the housing.

19. The motor with an encoder according to claim 5, wherein the disk is connected to the motor shaft without having an encoder shaft in between.

20. A motor with an encoder comprising:
a motor including a motor shaft and a housing;
a disk connected to the motor shaft and having a plurality of reflecting slits formed along a circumferential direction;
a light source configured to emit light to the reflecting slit;
a light-receiving element configured to receive light emitted from the light source and reflected by the reflecting slit;
a substrate provided with the light source and the light-receiving element; and
an encoder cover having an outer dimension smaller than that of the housing and attached to the housing so as to cover the disk and the substrate.
